(19) United States
(12) Patent Application Publication
(10) Pub. No.: US 2024/0403698 A1
(43) Pub. Date: Dec. 5, 2024

(54) DETECTION OF SIMILAR MACHINE LEARNING FEATURES IN REAL-TIME FOR DECLARATIVE FEATURE ENGINEERING

(71) Applicant: PAYPAL, INC., San Jose, CA (US)

(72) Inventors: Olga Sharshevsky, Holon (IL); Marina Lyan, Modi'in Makabim-Re'ut (IL); Damian Laufer, Kfar Saba (IL)

(21) Appl. No.: 18/325,844

(22) Filed: May 30, 2023

(51) Int. Cl. G06N 20/00

(52) U.S. Cl. CPC G06N 20/00

(57) ABSTRACT

There are provided systems and methods for detection of similar machine learning features in real-time for declarative feature engineering. A service provider, such as an electronic transaction processor for digital transactions, may utilize computing services that implement machine learning models for decision-making of data including real-time data in production computing environments. Machine learning models may utilize features or variables that may correspond to coded logic that provides a measurable datum, property, or the like to the models for intelligent outputs. When creating features, preexisting features may accomplish the same or similar function. Thus, the service provider may provide machine learning clustering of features for similarity detection in real-time. Feature clusters may be precomputed and loaded for comparison using representative vectors for clusters. Each feature may have a declarative definition of parameters that may be used for comparison, and similar detected features may be output during feature engineering.

### TECHNICAL FIELD

The present application generally relates to machine learning (ML) and other artificial intelligence (AI) feature engineering and more particularly to detecting similar features using feature attribute clustering and similarity distances.

### BACKGROUND

Users may utilize computing devices to access online domains and platforms to perform various computing operations and view available data. Generally, these operations are provided by different service providers, which may provide services for account establishment and access, messaging and communications, electronic transaction processing, and other types of available services. During use of these computing services, the processing platforms and services, the service provider may utilize one or more applications, platforms, and/or decision services that implement and utilize ML and other AI (e.g., neural networks (NN), rule-based engines, etc.) models for classifications, predictions, decision-making, and the like during data processing, such as within a production computing environment. For example, an ML model may be used for processing input data for one or more ML features and determining a classification, prediction, decision, or other output. ML models may be trained, tested, and generated for deployment using the features during a declarative feature engineering where the ML features are selected and/or constructed based on the behavior and output desired for the ML model. However, different features may be created and used by different data scientists for different ML models to retrieve and/or process the same or similar data, which may produce duplicate or very similar features that unnecessarily utilize computing resources and storages and may have different processing requirements and times. Further, feature engineering is time consuming, and engineering new features is more resource intensive and costly than utilizing previously created features. Thus, ML feature engineering and corresponding declarative features are not optimized to properly utilize and allow for feature comparison and similarity detection. As such, it is desirable to provide improved systems and processes for feature engineering that address various issues discussed above.

### BRIEF DESCRIPTION OF THE DRAWINGS

FIG. 1 is a block diagram of a networked system suitable for implementing the processes described herein, according to an embodiment;

FIG. 2 is an exemplary system environment where real-time feature similarity detection is performed based on feature clustering and feature similarity scores, according to an embodiment;

FIG. 3A is an exemplary diagram showing clusters of features with a cluster representative for feature comparison in real-time during feature engineering, according to an embodiment;

FIG. 3B is an exemplary diagram of a table showing a declarative definition of a first feature being compared to a declarative definition of a second feature using ML clustering and similarity detection operations, according to an embodiment;

FIG. 3C is an exemplary user interface for outputting results for feature similarity detection using ML clustering and similarity detection operations, according to an embodiment;

FIG. 4 is a flowchart of an exemplary process for detection of similar machine learning features in real-time for declarative feature engineering, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for detection of similar machine learning features in real-time for declarative feature engineering. Systems suitable for practicing methods of the present disclosure are also provided.

A service provider may provide different computing resources and services to users through different websites, resident applications (e.g., which may reside locally on a computing device), and/or other online platforms. When utilizing the computing services of a particular service provider, the service provider may provide different operations through applications, platforms, decision services, and the like that utilize ML models and other AI systems for intelligent decision-making operations with such services and to provide outputs to users. For example, an online transaction processor may provide computing services associated with electronic transaction processing, digital accounts and account services, user authentication and verification, digital payments, risk analysis and compliance, and the like. Other exemplary services may include shopping and merchant marketplaces, social networking, microblogging, media sharing, messaging, business and consumer platforms, etc. These services may further implement automated and intelligent decision-making operations and engines through ML models. These decision services may determine if, when, and how a particular service may be provided to users. For example, risk ML models may be utilized by a risk ML engine to determine whether electronic transaction processing of a requested digital transaction may proceed or be approved. The risk ML engine may determine whether to proceed with processing the transaction or decline the transaction (as well as additional operations, such as request further authentication and/or information for better risk analysis).

Different ML models may utilize different ML features, also referred to herein as an ML “variable” or “variables” for ML models, where features (or variables) may correspond to an individual measurable datum or pieces of data correspond to a data record, such as a specific column or other recorded data for a property, characteristic, parameter, or the like for the data record (e.g., a transaction amount, date, payer and payee, etc., for a transaction). Features may have corresponding data that may be extracted from training and testing data during ML model training, as well as input data for ML model classifications and outputs. Features may have data that may be operated on to generate feature vectors, which may correspond to mathematical representatives of the corresponding feature data. For example, different layers, nodes, clusters, and the like may be used with features and a corresponding ML algorithm or technique to generate representative vectors of input data for features.

Feature engineering may be performed to extract features and/or perform feature discovery using domain knowledge and/or declarative ML engineering to determine features from raw data. Data scientists may generate features during feature engineering using declarative feature definitions and the like, such as by defining feature parameters and properties for the corresponding feature declaration (e.g., desired outcome or processing result for the feature and/or ML model). Thus, feature declaration may correspond to a data file from selections, inputs, and the like for parameters such as source tables, transformation logic, windowing (e.g., time-based windows and the like), and/or filters and their corresponding definitions. However, different data scientists and other users or engineers may generate different features for different ML models, which may overlap in function and definition, and therefore the same or similar features may be created. This causes duplicated features that unnecessarily consume time and resources to create and waste storage and data processing resources while causing feature engineering operations to have unnecessary and difficult to navigate feature selection. For example, two central aspects of feature engineering at scale are time to market (TTM) and total cost of ownership (TCO). To address this problem of data scientists developing thousands of features that may overlap or be duplicative, the service provider may implement a feature similarity detection system, feature clustering and cluster representative ML operations and models, and a feature selection and identification user interface (UI) to efficiently detect similar existing features that may be reused for ML model feature engineering and training. This may significantly reduce TTM of ML development and the underlying costs of developing, productizing, point-in-time time travel, backfill, and maintenance of the new features. A UI system may allow data scientists and other users to write a declaration of desired features and what those features include and operate on, as well as how those feature function, instead of explicitly specifying how to construct the features on top of different execution platforms (e.g., batch/near-real-time or real-time). Using the UI system for feature similarity detection, the user may configure the desired feature logic, and similar features may be detected from feature clusters with a detailed summary of which parts of the declaration are identical, similar, and/or different.

The UI system may be used to construct, write, and/or otherwise generate features or variables used for ML models. For example, each feature or variable, container, or file thereof, fetches, retrieves, loads, processes, and/or converts particular data (e.g., one or more pieces or measurable property of account data, device data, user data, transaction data, etc.) that is utilized in ML processing by the ML engine for automated intelligent decision-making. Thus, a feature or variable may correspond to a piece or portion of data for processing from a certain resource, which may be constrained by time or other window and/or filtered and may further be operated on by transformation logic and the like. For example, a feature may correspond to account information, where the available data objects that request, determine, or retrieve account information may include an account number, username, user information, user/account identifier, and the like. When training ML models, an ML model training, testing, and deployment application may be utilized by a data scientist, engineer, or the like in order to designate one or more features. However, two or more features may be correlated in that they retrieve, load, transform, or otherwise operate on and/or provide the same or similar data and provide the same or similar feature for ML models. These correlated features or variables may have the same and/or different processing costs, weights, loads, and/or loading times, which may affect determination of duplicate features or variables and/or features or variables that may be better optimized for the same or similar feature.

In this regard, data scientists may define feature logic for a feature that already exists or is very similar and may provide the same or similar input for an ML model, as well as not select the available and/or optimized feature or variable, thereby wasting system resources and/or adding to unnecessary features and components in ML modeling systems. In order to detect and determine similar features when feature declarations for feature definitions are received, the service provider may first implement an ML clustering engine and operations for the features based on the features parameters, properties, and/or definitions, such as a source table, transformation logic, a windowing parameter, or a filter definition. Such a system may operate offline and/or asynchronously from the feature similarity detection, thereby not requiring clustering of features in real-time and/or when requested. The ML clustering engine may compute the similarity score for every pair of features (e.g., between each feature and every other feature). This may be done using vectors computed from each feature based on the feature's declarative definition and corresponding feature parameters. Each vector may be computed as a mathematical representation, such as a number, alphanumeric string, data table or matrix, or the like of a particular dimensionality depending on the feature parameters and/or clustering operations.

As the feature declaration may be a JavaScript Object Notation (JSON) file, or similar file or data container, which may include or define source tables, transformation logic, windowing, and filters definition, features defined on the same source tables but with slightly different filters, aggregate functions, and time windows may have the same contribution to the ML model performance. Thus, similar features are likely to be reused and similarity may be determined using similarity scores between features. Feature parameters from feature declarations and from stored feature definitions of previously generated features may be used for clustering. The ML clustering engine may access and/or receive the set of previously generated and/or stored features for the ML training system and precompute feature similarity clusters according to the similarity scores between each feature, as well as based on the business domain and/or organization of the feature creator. For clustering, one or more ML clustering algorithms may be utilized, such as K-nearest neighbors (K-NN) classification algorithm (or other density, distribution, centroid, or hierarchical-based clustering that may be optimized for clustering using ML feature declarations and parameters).

When precomputing the clusters, one or more features may be assigned to each cluster, and a cluster representative vector or sample feature may be determined for each cluster. A cluster representative vector may correspond to an average or other representative vector or feature used to identify the cluster and the same or similar features in such cluster. Thus, as the clusters contain objects for each feature in the cluster, the “most similar” to other members in the group may be identified (e.g., as a stored and/or available feature for ML training) or created (e.g., as a representative vector or feature without an actual corresponding feature) for each cluster. Cluster data for the clusters of features, the corresponding membership of features in each cluster, and the cluster representatives may then be generated and stored for use by one or more ML modeling applications during feature declarations and engineering. Such data may be stored locally and/or accessible to the ML modeling or other ML creation application in real-time and/or during feature engineering in order to provide availability for real-time feature similarity detection.

Thus, the cluster data from the ML clustering process by the ML clustering engine may be stored in a local access (e.g., device-side, cache, etc.) and/or made available for use during feature engineering operations. The cluster data may reside locally for the client device and/or client application performing feature declaration and/or engineering, and the cluster data may further be updated periodically, when new features are clustered, and/or when cluster data is updated. Thereafter, the UI system for ML modeling and training may receive a feature declaration for a new feature to be used with an ML model during modeling and training. Without requiring the client to go to a server to retrieve the cluster data, the client may then retrieve the cluster data for feature or variable comparisons and real-time feature or variable similarity detection. This may allow for faster and real-time similarity detection using pre-clustered data that is accessible from a local, device-side, and/or faster storage. In further embodiments, the cluster data may also or instead be stored and/or made accessible elsewhere, such as a centralized data repository, cloud computing system and/or storage nodes, edge computing storage nodes, and the like.

Features or variables may then be compared based on their corresponding declarations and/or parameters (e.g., for each feature's definition). This may include generating a vector or other representation of the input feature parameters, declaration, and/or definition, including individual parameters and/or sets of parameters, and determining nearest or most closely matching clusters using similarity scores between other features and/or cluster representatives. For example, vectors may be generated for the feature declarations and compared, using similarity scores, to existing features using the clusters of features and/or the cluster representatives (e.g., vectors or feature representations for a cluster). One or more clusters may be identified that are similar within a threshold score or distance to the feature declaration's parameters and/or definition, and an output may be provided to the user that shows the same or similar features from past ML feature engineering and modeling.

For example, with two or more features or variables that perform the same or similar function, an existing feature or variable may be suggested (e.g., most similar, which may also include multiple features similar within a similarity threshold score or distance). This may be output via the UI of the UI system, such as in one or more fields and may present the similarity score, clusters and/or cluster members of features that are similar to the feature declaration, and the like. This allows the UI to show a most optimized feature or variable that exists in the ML modeling system for selection in ML modeling and feature engineering. Thus, the data scientists or other users may make optimized selections during ML modeling and construction based on existing features instead of spending additional time during feature engineering. Further, the optimization operation for features or variables within existing ML models may also retroactively analyze features that have previously been deployed into one or more decision services in order to optimize features and reduce duplicated features. However, if no feature currently exists, the user may be provided with options and operations to continue with feature declaration and engineering.

Thereafter, a service provider, such as an online transaction processor (e.g., PayPal®), may provide services to users, including electronic transaction processing that allows merchants, users, and other entities to processes transactions, provide payments, and/or transfer funds between these users. When interacting with the service provider, the user may process a particular transaction and transactional data to provide a payment to another user or a third-party for items or services. Moreover, the user may view other digital accounts and/or digital wallet information, including a transaction history and other payment information associated with the user's payment instruments and/or digital wallet. The user may also interact with the service provider to establish an account and other information for the user. In further embodiments, other service providers may also provide computing services, including social networking, microblogging, media sharing, messaging, business and consumer platforms, etc. These computing services may be deployed across multiple different applications including different applications for different operating systems and/or device types. Furthermore, these services may utilize the aforementioned ML models and systems for intelligent decision-making, classification, predictions, and other outputs, where ML features for such models may utilize feature selection and optimization from preexisting features using the processes described herein for feature similarity detection.

In various embodiments and to utilize computing services using ML models and engines, an account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation, as well as purchase or subscribe to services of the service provider. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services. Access and use of these accounts may be performed in conjunction with uses of the aforementioned ML models and engines.

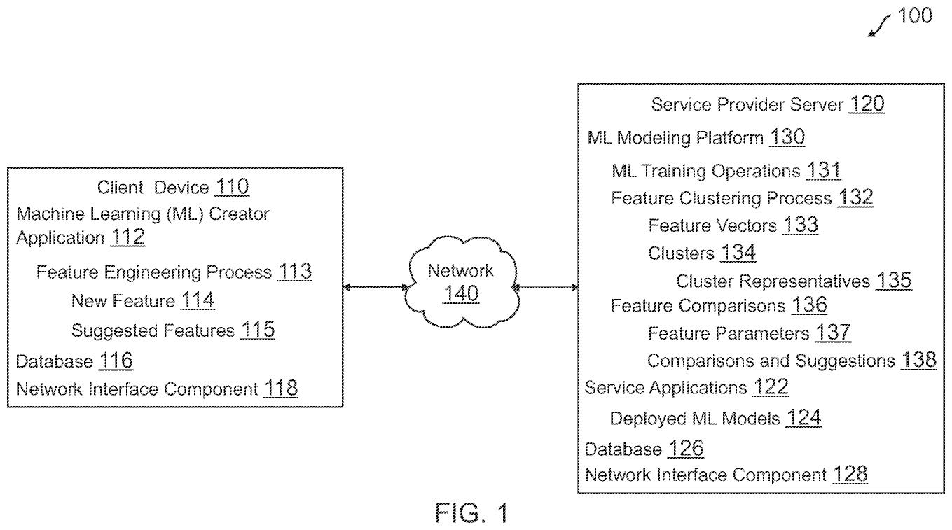

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110 and a service provider server 120 in communication over a network 140. Client device 110 may be utilized by a user to access a computing service or resource provided by service provider server 120, where service provider server 120 may provide various data, operations, and other functions to client device 110 via network 140 including those associated with ML modeling and feature engineering. In this regard, client device 110 may be used to declare features and/or feature parameter or feature outputs, which may be used for real-time feature comparison and similarity detection. Service provider server 120 may provide clustering operations and cluster data prior to similarity detection, which may be provided to client device 110 prior to and/or during feature comparisons for detection of similar features.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a communication device that may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Client device 110 of FIG. 1 contains an ML creator application 112, a database 116, and a network interface component 118. ML creator application 112 may correspond to executable processes, procedures, and/or applications with associated hardware. In other embodiments, client device 110 may include additional or different modules having specialized hardware and/or software as required.

ML creator application 112 may correspond to one or more processes to execute software modules and associated components of client device 110 to provide features, services, and other operations for writing, constructing, and/or declaring features and features parameters for ML models. In this regard, ML creator application 112 may correspond to specialized hardware and/or software utilized by a user of client device 110 that may be used to access a website or UI provided by service provider server 120 for ML modeling and training operations. ML creator application 112 may utilize one or more UIs, such as graphical user interfaces presented using an output display device of client device 110, to enable the user associated with client device 110 to enter and/or view data, navigate between different data, UIs, and executable processes, and request processing operations based on services for ML modeling and feature engineering provided by service provider server 120. In some embodiments, the UIs may display features and/or feature parameters that may be used for feature declarations of features that may be created and used with one or more ML models. In order to do this, ML creator application 112 may render a UI during application execution, which may correspond to a webpage, domain, service, and/or platform provided by service provider server 120.

In some embodiments, features considered for construction and/or generation using ML creator application 112, such as based on selected feature parameters and/or a feature declaration for a feature, may be compared to existing features available with an ML modeling system, ML models, and/or feature engineering operations and applications for service provider server 120. For example, service provider server 120 may implement and utilize ML models with one or more processing engines, decision services, applications, and the like for electronic transaction processing services and intelligent decision-making, such as those associated with transaction processing, digital accounts and account services, user authentication and verification, digital payments, risk analysis and compliance, and the like. In further embodiments, different services may be provided that utilize ML models, including messaging, social networking, media posting or sharing, microblogging, data browsing and searching, online shopping, and other services available through online service providers.

During operation, such as when performing feature engineering and/or providing a feature declaration, ML creator application 112 may display one or more operations, menus, fields, or the like for feature construction using a feature engineering process 113, which may utilize different feature parameters available in ML creator application 112 (e.g., source tables, transformation logic, windowing, filters, etc.). When creating new features, such as new feature 114, via feature engineering process 113, ML creator application 112 may further display other similar features that currently exist, were previously created, and/or are or were used by ML models in the ML modeling and training system, such as suggested features 115 for new feature 114 that may be provided by service provider server 120 and are or were implemented in one or more ML models. To do this, ML creator application 112 may receive, access, and/or load cluster data for ML clustering of those preexisting features, where clusters may include one or more feature members and cluster membership, as well as a cluster representative (e.g., a feature, average, or representative vector) for each cluster. The input feature declaration of feature parameters for new feature 114 may be compared, such as through similarity and/or distance scores (e.g., using representative vectors) of the new and preexisting features or cluster representatives, and an output of similar clusters, members in similar clusters, and the like may be provided as suggested features 115. Such processing may occur on-device and in-client for ML creator application 112 or may be performed in part, in conjunction with, or wholly by service provider server 120.

Client device 110 may further include database 116 stored on a transitory and/or non-transitory memory of client device 110, which may store various applications and data and be utilized during execution of various modules of client device 110. Database 116 may include, for example, identifiers such as operating system registry entries, cookies associated with ML creator application 112 and/or other applications 114, identifiers associated with hardware of client device 110, or other appropriate identifiers, such as identifiers used for payment/user/device authentication or identification, which may be communicated as identifying the user/client device 110 to service provider server 120. Moreover, database 116 may include data and information used for similarity detection of features for comparison of existing features to feature declarations, such as cluster data for clusters of features and corresponding cluster representatives.

Client device 110 includes at least one network interface component 118 adapted to communicate with service provider server 120. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide services that use ML models having ML features to process data. Such ML models may be implemented with applications, platforms, decision services, and the like to perform automated decision-making in an intelligent system. In this regard, service provider server 120 includes one or more processing applications which may be configured to interact with client device 110 to generate and deploy ML models based on ML feature selections and engineering, which may include feature similarity detection to prevent unnecessary feature creation and provide preexisting features for ML modeling. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes an ML modeling platform 130, service applications 122, a database 126, and a network interface component 128. ML modeling platform 130 and service applications 122 may correspond to executable processes, procedures, and/or applications with associated hardware. In other embodiments, service provider server 120 may include additional or different modules having specialized hardware and/or software as required.

ML modeling platform 130 may correspond to one or more processes to execute modules and associated specialized hardware of service provider server 120 to provide a platform, application, and framework to generate, model, and/or train ML models, which may include operations to create features and/or perform feature engineering for during ML modeling. In this regard, ML modeling platform 130 may correspond to specialized hardware and/or software used by service provider server 120 to first perform a ML clustering of features available for a particular domain, ML task, ML model or set of models, and/or designate feature set, or may cluster all available features in an ML system or modeling application. The ML clustering may result in cluster data that may later be performed for real-time similarity detection of similar, matching, or corresponding features from comparing, in real-time such as during application runtime and/or in a test or production computing environment when feature engineering occurs, preexisting features to feature declarations of new features. Thus, the ML clustering operations may be performed prior to real-time similarity detection, including in an offline environment and/or prescheduled or batch processing jobs.

To perform ML modeling and training, ML modeling platform 130 includes ML training operations 131. Such operations may be used to select, designate, and/or load training data and/or test data, partition data into training, test, and/or validation datasets, perform feature selection and/or feature engineering, and train/adjust ML models prior to deployment. For ML models, features are selected that correspond to measurable properties, observations, or other datum for data records or data sets and may be ingested by the ML models to product an output intelligent classification, decision, prediction, or the like. Thus, ML modeling platform 130 may implement cluster data to perform feature similarity detection in order to reduce duplicated features and/or overlapping features that accomplish the same or similar effects or data input goals for ML models in order to reduce system load, stress, excess data and feature processing operations, and unnecessary or confusing feature selections. This also reduces the time and processing costs of designing and generating new features when new models are trained and/or existing models are updated, reconfigured, or retrained.

ML modeling platform 130 includes a feature clustering process 132 that may correspond to one or more of density, distribution, centroid, or hierarchical-based clustering for different data points, such as vector of n-dimensionality, where n may correspond to the feature parameters, properties, or the like from feature definitions and declarations. Thus, each feature may have a dimensionality and values that may be expressed as a mathematical representation through a vector (e.g., a numeric value, table, matrix, etc.). Feature vectors 133 may be calculated and determined from each feature, including preexisting features that are processed from available, accessed, or received feature data of those existing features and their definitions, as well as new features and/or feature declarations that are being considered for generating a new feature for ML modeling and training of an ML model.

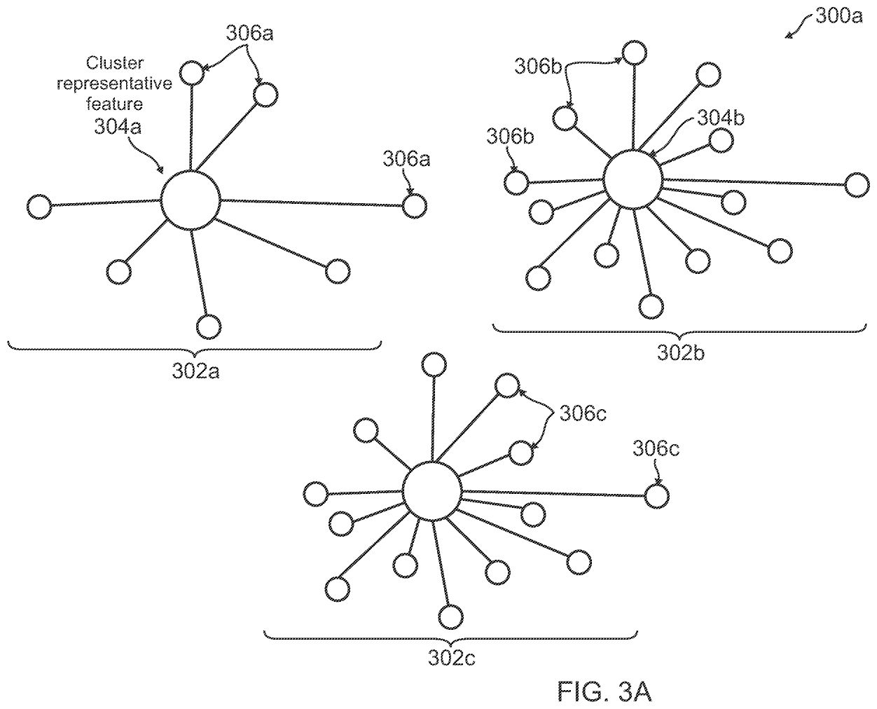

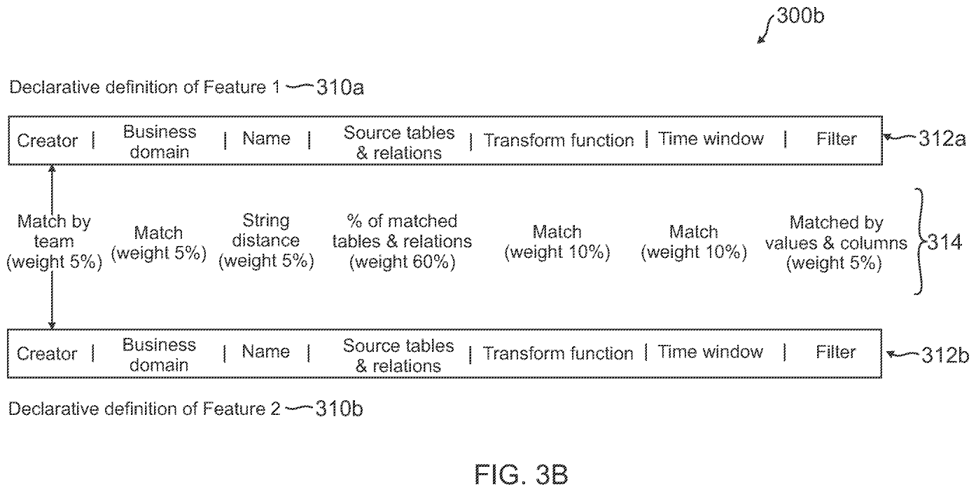

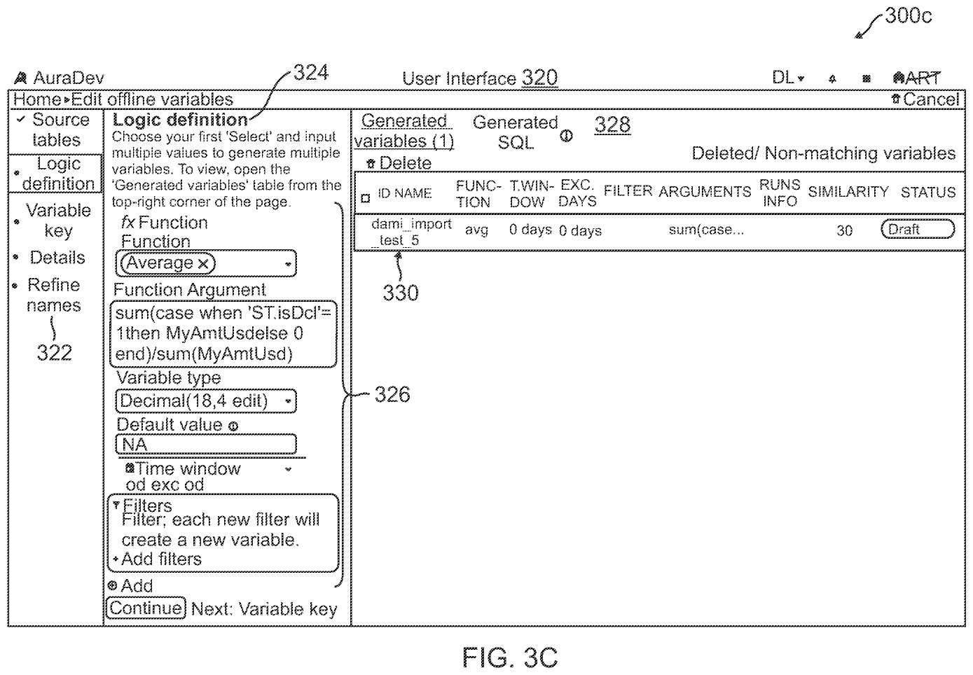

Thereafter, feature clustering process 132 may execute operations that implement or use a clustering algorithm, such as a K-NN classification algorithm or other supervised or unsupervised learning classifier that may perform classifications and/or predictions by grouping data points (e.g., feature vectors 133) based on similarity scores, distance scores or functions, and the like. The clustering algorithm may be used to generate clusters 134, which may have cluster representatives 135 that represent clusters 134 as an average, middle data point or representation, and/or representative vector. Cluster representatives 135 may be selected as a representative one of feature vectors 133, and underlying feature, for each of clusters 134 or may be calculated and generated to represent clusters 134. An exemplary diagram of the clustering algorithm and resulting outputs of clusters 134 with cluster representatives 135 from feature vectors 133 is described in further detail with regard to FIG. 3A below. Feature vectors 133, clusters 134, and/or cluster representatives 135 may be used to generate cluster data, which may be provided to client device 110 and/or stored by database 126 for use in real-time similarity detection of features during feature declaration and/or engineering.

Thereafter, feature comparisons 136 may be computed by comparing vectors or other representations for new features and/or their feature declarations (e.g., new feature 114 and/or a corresponding feature declaration for feature parameters) to clusters and/or cluster representatives 135. This may be based on feature parameters 137 for the new features and existing features. For example, similarity scores or distances for vectors and/or vector distances (or other similarity metric) in an n-dimensional vector space may be computed between new feature 114 and clusters 134 (e.g., based on feature parameters 137 and using feature vectors 133) and/or cluster representatives 135 to determine matching clusters, which may generate comparisons and suggestions 138 for features matching or similar to the feature declaration of the new feature based on feature parameters 137. Comparisons and suggestions 138 may then be output, which may include suggested features 115 determined for new feature 114, which may be output to one or more users via a UI system and/or UI of an application including ML creator application 112. Although feature comparisons 136 are shown as being determined by ML modeling platform 130, in some embodiments, feature comparisons 136 may be performed by ML creator application 112 using the cluster data provided to client device 110. For example, ML creator application 112 may include the same or similar operations described above to determine feature comparisons 136 as an in-app feature and operations to provide client-side real-time similarity detection of preexisting features to feature declarations, which may similarly be used to provide suggested features 115 to new feature 114. Additionally, features and computing service provided by ML modeling platform 130 may be utilized through ML creator application 112 that displays UIs from service provider server 120.

Service applications 122 may correspond to one or more processes to execute modules and associated specialized hardware of service provider server 120 to process a transaction or provide another computing service, which may be assisted by deployed ML models 124 from ML modeling operations utilized through ML modeling platform 130. In this regard, service applications 122 may correspond to specialized hardware and/or software used by a user associated with client device 110 to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider server 120. In some embodiments, the financial information may also be used to establish a payment account. Accounts may be accessed and/or used through one or more instances of a web browser application and/or dedicated software application executed by client device 110 and engage in computing services provided by service applications 122.

The account may be accessed and/or used through a browser application and/or dedicated payment application executed by client device 110 and engage in transaction processing through service applications 122. Service applications 122 may process the payment and may provide a transaction history to client device 110 for transaction authorization, approval, or denial. Such account services, account setup, authentication, electronic transaction processing, and other services of service applications 122 may utilize deployed ML models 124, such as for risk analysis, fraud detection, and the like. In other embodiments, service applications 122 may instead provide different computing services, including social networking, microblogging, media sharing, messaging, business and consumer platforms, etc. Such services may similarly utilize deployed ML models for intelligent outputs.

For example, in some embodiments, deployed ML models 124 may correspond to ML clustering models and ML generated clusters, decision tree models and corresponding decision trees from decision tree algorithms or training operations, NNs. and the like. Cluster-based models may include clustering using a clustering algorithm (e.g., density, distribution, centroid, or hierarchical-based clustering). Decision trees may include one or more input nodes or other mathematical computations associated with features, additional or hidden processing nodes, and output nodes that form branches where different computations at each node, activation functions, thresholds or value computations and comparisons, and the like may be used to proceed down different branches to a particular output. Similarly, NNs may use nodes linked in different layers to form neurons that may include input, hidden, and output layers. Thus, ML models with one or more layers, including an input layer, a hidden layer, and an output layer having one or more nodes, may be implemented as deployed ML models 124. As many hidden layers as necessary or appropriate may be utilized. Each node within a layer is connected to a node within an adjacent layer, where a set of input values may be used to generate one or more output values or classifications. Within the input layer, each node may correspond to a distinct attribute or input data type that is used for the ML model algorithms using feature or attribute extraction for input data.

Thereafter, the internal, interceding, or hidden layers and/or nodes may be generated with these attributes and corresponding weights using an ML algorithm, computation, and/or technique. For example, each of the nodes in the hidden or internal layers generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for deployed ML models 124 that provide an output, classification, prediction, or the like. Thus, when deployed ML models 124 are used to perform a predictive analysis and output, the input may provide a corresponding output based on the classifications trained for deployed ML models 124.

By providing input data when generating deployed ML models 124 using the ML model algorithms, the nodes in the layers may be adjusted such that an optimal output (e.g., a classification) is produced in the output layer. By continuously providing different sets of data and penalizing ML models when the output of deployed ML models 124 is incorrect, the ML model algorithms for deployed ML models 124 (and specifically, the representations of the nodes in the layers, branches, neurons, or the like) may be adjusted to improve its performance in data classification. Using the ML model algorithms, deployed ML models 124 may be created to perform intelligent decision-making and predictive outputs. This may include those implemented by applications, platforms, decision services, and the like.

Service applications 122 may also provide additional features to service provider server 120. For example, service applications 122 may include security applications for implementing server-side security features, programmatic client applications for interfacing with appropriate application programming interfaces (APIs) over network 140, or other types of applications. Service applications 122 may contain software programs, executable by a processor, including one or more GUIs and the like, configured to provide an interface to the user when accessing service provider server 120, where the user or other users may interact with the GUI to more easily view and communicate information. In various embodiments, service applications 122 may include additional connection and/or communication applications, which may be utilized to communicate information to over network 140.

Additionally, service provider server 120 includes database 126. Database 126 may store various identifiers associated with client device 110. Database 126 may also store account data, including payment instruments and authentication credentials, as well as transaction processing histories and data for processed transactions. Database 126 may store financial information and tokenization data. Cluster data for clusters 134 and cluster representatives 135 may also be stored by database 126, which may be provided to client device 110 for real-time similarity detection of preexisting features from feature declarations.

In various embodiments, service provider server 120 includes at least one network interface component 128 adapted to communicate client device 110 and/or other devices or servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

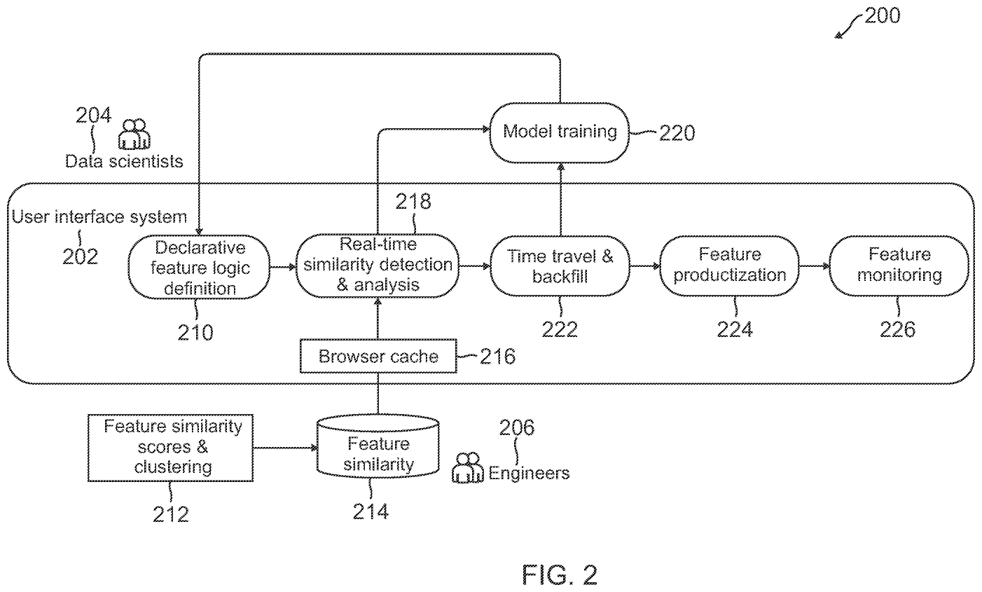

FIG. 2 is an exemplary system environment 200 where real-time feature similarity detection is performed based on feature clustering and feature similarity scores, according to an embodiment. System environment 200 of FIG. 2 includes an online or real-time processing environment and an offline or asynchronous (e.g., not in real-time and prior to real-time similarity detection for features) processing environment, which may correspond to those computing and processing environments provided by ML creator application 112 and/or ML modeling platform 130 discussed in reference to system 100 of FIG. 1. In this regard, a UI system 202 may be provided to data scientists 204 on a computing device to request operations, navigate between UIs and data, and otherwise interact with service provider server 120 for feature similarity detection during feature declaration in real-time, as discussed with respect to system 100.

System environment 200 shows how ML modeling platform 130 may provide cluster data that may be used to provide real-time similarity detection of similar, overlapping, or matching features, such as based on a feature declaration (e.g., the desired result of the feature for input data and/or the features parameters and properties) for a new feature and preexisting features' definitions for parameters and properties. In this regard, engineers 206 may provide data utilized for real-time similarity detection for ML features during feature engineering or other creation of declarative features. For example, data scientists 204 may interact with UI system 202 to provide a declarative feature logic definition 210, such as via one or more UIs, user inputs, menus, fields, and/or other input and UI elements that accept input for establishing declarative feature logic definition 210. This may correspond to a feature definition and/or logic for the parameters and/or properties of a feature provided in declarative form through UIs and menus of UI system 202. In order to determine if the same or similar feature already exists with the ML modeling system and/or ML models deployed in computing services for a domain of a service provider, engineers 206 may generate data for comparison, such as cluster data for clustered features that may be used for comparison through similarity scores. As such, engineers 206 may perform operations to compute feature similarity scores and clustering 212. This may utilize an ML clustering algorithm with an ML model or engine for cluster generation of feature clusters using preexisting features and feature definitions. Feature similarity 214 may then be generated at clustered feature data, cluster representatives, and the like, which may be stored in a database for access by UI system 202 during real-time similarity detection for declarative feature engineering. The operations to generate and provide access to feature similarity (e.g., by engineers 206) may be provided in an offline or asynchronous processing job and/or environment for later use in real-time by UI system 202.

Thereafter, when data scientists 204 provide declarative feature logic definition 210 for a new feature, real-time feature similarity detection may be performed. A browser cache 216 or the like may receive feature similarity 214 from a database, such as on startup, prior to application execution, and/or on or during application execution (e.g., when performing declarative feature engineering operations). The data for feature similarity 214, such as the clusters and cluster representatives, may be accessed by UI system 202 after storage in browser cache 216 and then used for real-time similarity detection and analysis 218. This includes determining distances or similarity scores between the feature declaration from declarative feature logic definition 210 and the features (e.g., by their vectors, vector clusters, and/or cluster representatives) from feature similarity 214. UI system 202 may then output similar, matching, or otherwise correlated features from real-time similarity detection and analysis 218, which may be provided for review in one or more UIs with corresponding data for the comparison, feature, and/or feature's definition or declaration. Thus, the user may define the feature logic for the new feature as a declaration of the feature for analysis and similarity detection without generating the new feature. Thereafter, model training 220 may be performed for the ML model using the selected preexisting features that may, in part, be selected based on suggestions of existing features instead of new feature creation from the similarity detection. Model training 220 in UI system 202 may also include time travel and backfill 222, feature productization 224, and feature monitoring 226 for further updating of feature similarity 214 and/or other cluster data and feature clusters, such as to maintain up-to-date similarity scores between feature, cluster memberships, and/or cluster representatives.

FIG. 3A is an exemplary diagram 300a showing clusters of features with a cluster representative for feature comparison in real-time during feature engineering, according to an embodiment. Diagram 300a includes clusters 302a-302c, which may correspond to clusters of account features or the like that are generated from an ML clustering operation using an ML clustering algorithm, such as K-NN classification and clustering, other K-means and/or nearest neighbor clustering technique, or the like. In this regard, clusters 302a-302c may be determined by service provider server 120, discussed in reference to system 100 of FIG. 1, for use in similarity detection during declarative feature engineering.

In diagram 300a, clusters 302a-302c each have a cluster membership including the features, based on their vectors or other representation in a space used for clustering, that have been clustered using the clustering algorithm. Further, clusters 302a-302c are represented by cluster representative features 304a-304c, which may correspond to an actual or representative feature and corresponding vector as an average or other value chosen to represent each corresponding cluster's membership. For example, cluster 302a includes cluster representative feature 304a for features 306a represented in a vector space (e.g., an n-dimensional vector space for corresponding feature vectors). Similarly, cluster 302b includes cluster representative feature 304b for features 306b, and cluster 302c includes cluster representative feature 304c for features 306c. Each feature or variable and corresponding feature or variable definition may correspond to a parameter, description, or identifier (including IDs for data and/or data objects). The definition or other declaration of the features may be parsed, converted to vectors, and clustered in order to determine similar features or vectors. For example, a feature definition may include “account first name,” and may further include a resource or source data table used to load the account first name in certain embodiments. Thus, variables that include the same or similar definition or identifier, e.g., account first name, may be correlated.

When generating clusters 302a-302c, features 306a-306c may be represented in a space and clustered according to their vectors or other representations and the clustering algorithm. This allows for identification of features that may have similar logic and/or definitions, such as those that are associated with account information, transaction information, transaction histories or fraudulent/non-fraudulent transactions, and other correlated feature data. Clustering of features 306a-306c allows for identification of similar and/or overlapping features so that comparisons of a new feature and/or that new feature's declaration (e.g., selected parameters for name, description, definition, logic, etc.) may be performed. Further, by representing clusters 302a-302c and their corresponding features 306a-306c using cluster representative features 304a-304c, similarity detection using similarity scores and/or distances in the vector space may be done by calculating similarities between the new feature's vector and vectors for cluster representative features 304a-304c. This lightens the processing load during similarity detection by not requiring a comparison to each individual feature and instead to clusters 302a-302c, where thereafter each cluster meeting or exceeding a similarity threshold may be identified, provided as output for review, and/or further compared to determine a subset of the features from the cluster's membership that are most similar.

FIG. 3B is an exemplary diagram 300b of a table showing a declarative definition of a first feature being compared to a declarative definition of a second feature using ML clustering and similarity detection operations, according to an embodiment. Diagram 300b includes a declarative definition 310a of a feature 1 and a declarative definition of a feature 2 for features utilized by ML models and engines of a service provider, such as service provider server 120 discussed in reference to system 100 of FIG. 1. In this regard, declaration definitions 310a and 310b may be used for clustering of features as shown in diagram 300a of FIG. 3A.

In diagram 300b, feature 1 has declarative definition 310a including parameters 312a, while feature 2 has declarative definition 310b including parameters 312b. Vector similarity weights 314 may be applied to each of parameters 312a and 312b in order to calculate vectors or other mathematical representations of feature 1 and feature 2 and compare using declarative definition 310a and declarative definition 310b, respectively. For example, parameters 312a and 312b may correspond to the different vector calculation inputs and/or dimensions, each of which is weighted by one (or more, if a more complex weight calculation is utilized) by factors, coefficients, operators, and/or other calculations from vector similarity weights 314. Thus, when vector similarity weights 314 are applied to parameters 312a and 312b, resulting vectors or other outputs may be received, which may be used for clustering in a space through implementation of a clustering algorithm or technique.

When calculating a vector for each of feature 1 and feature 2, parameters 312a and 312b may include a creator, a business domain, a name, source tables and relations, a transform function, a time window, and a filter. More, less, or different parameters for different declarative definitions may also be used, which may be domain, feature, and/or ML model dependent. In declarative definitions 310a and 310b, vector similarity weights 314 applied to parameters 312a and 312b each have a corresponding weight amount to their value, encoding, or input as a particular vector value. Thus, the vectors may correspond to a numerical or other mathematical representation of parameters 312a and 312b and compared once weighted by vector similarity weights 314.

For example, creator matching by team is weighted by 5%, business domain match by 5%, name comparison via string distance by 5%, a percentage of matched tables and relations by 60%, a transform function match by 10%, a time window match by 10%, and a filer matched by values and columns by 5%. Different weights and values may also be used. This allows for comparison of the vectors for features 1 and 2, from parameters 312a and 312b in declarative definitions 310a and 310b, respectively, for similarity score calculation and clustering or other comparison (e.g., for similarity detection). In other embodiments, instead of features 1 and 2 being preexisting features with a ML modeling and training system, such as a UI system for feature engineering and selection, ML training, and other ML modeling systems, one of features 1 or 2 may be a new feature and/or new feature's declaration. In such embodiments, the vector from the new feature's declarative definition may then be used for comparison and similarity detection, such as by comparing to the other one of feature 1 or 2 that preexists with the system or may correspond to a cluster representative for a cluster of features.

FIG. 3C is an exemplary user interface 300c for outputting results for feature similarity detection using ML clustering and similarity detection operations, according to an embodiment. User interface 300c may correspond to an output UI from a UI system that is presented to users during feature engineering and/or other input of a declarative definition for a feature considered for creation and/or use. In this regard, user interface 300c may be displayed by client device 110 using ML creator application 112, discussed in reference to system 100 of FIG. 1.

In user interface 300c, a user may interact with the corresponding UI system for declarative feature engineering that provides feature similarity detection to prevent or reduce duplicate feature creation, which wastes time and computing resources. As such, the UI system may utilize cluster data, such as feature similarity data and clusters of preexisting features, to perform similarity comparisons to other existing features. Thus, a user may navigate to and/or provide input to user interface 300c while performing feature or variable engineering, where a menu 322 allows for input of different feature information, definitions, and parameters. Using menu 322, the user may then provide a logic definition 324 for a new feature, such as by declaring the desired operations of the new feature in place of creating and engineering the feature. Logic definition 324 includes parameters 326 that may be selected from menus, entered as input, or otherwise provided for the new feature's declarative definition.

Thereafter, the processors utilized by the UI system may perform feature comparisons and similarity detection, such as by comparing a vector or other representation of the data entered to logic definition 324 for parameter 326 to clusters and/or cluster representative vectors for preexisting features with the UI system and ML modeling operations. In a window 328 of user interface 300c, similar features may be provided back to the user based on the comparison and similarity detection. For example, a preexisting feature 330 may be provided that matches or is similar to the new feature's declaration from logic definition 324. This may be based on their similarity score or other comparison measurement meeting or exceeding a threshold score, rank, or other comparison value.

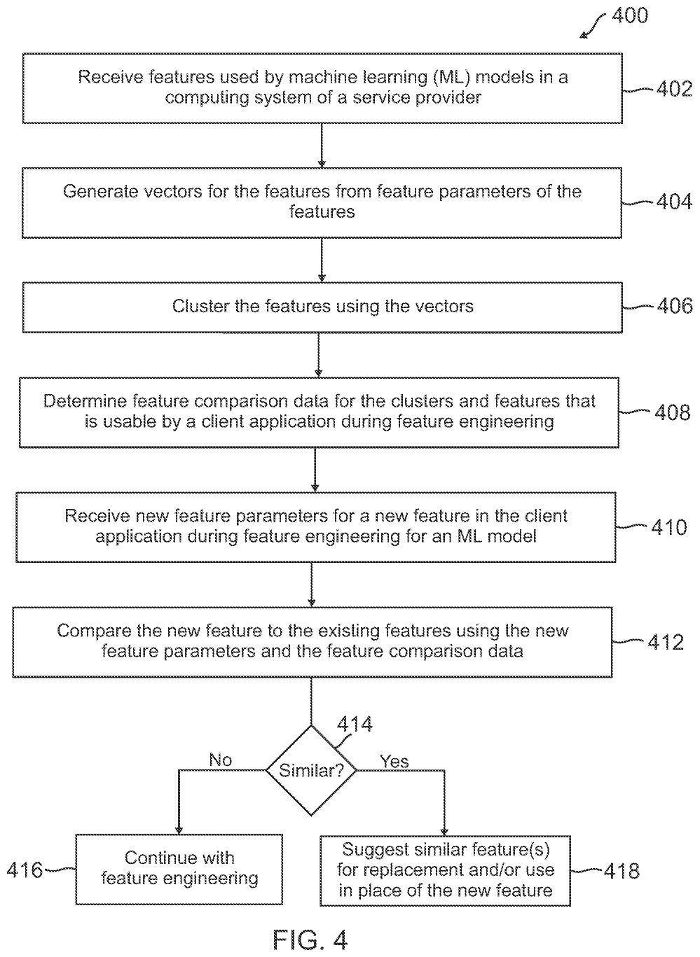

FIG. 4 is a flowchart 400 of an exemplary process for detection of similar machine learning features in real-time for declarative feature engineering, according to an embodiment. Note that one or more steps, processes, and methods described herein of flowchart 400 may be omitted, performed in a different sequence, or combined as desired or appropriate.

At step 402 of flowchart 400, features used by ML models in a computing system of a service provider are received. The features may be preexisting features utilized by different ML models and/or configured by data scientists and the like during feature engineering for ML model training. At step 404, vectors for the features are generated from feature parameters of the features and/or other feature logic and properties (e.g., a feature declaration or definition). Vectors may be calculated and/or generated based on the underlying dimensions for the parameters of the feature (e.g., data entries for a data record for a feature or other definition of that feature) by generating a mathematical representation of that feature. Such representation may correspond to a number, a table, a matrix, or other vector, which may have a dimensionality to represent the feature's parameters.

At step 406, the feature are clustered using the vectors. A clustering algorithm, such as a K-NN classification algorithm may be used to generate X number of clusters based on similarity scores between each of the features and other ones of the features, which may be based on their corresponding vectors or other mathematical representatives. For example, the vectors may be used to represent the features in a vector space, such as an n-dimensional space corresponding to n number of dimensions (e.g., parameters or defined logic) for the features. The vectors may then be used to compute similarity scores, which may then be used for clustering according to the clustering algorithm, cluster membership thresholds and/or scored distances, and the like. Cluster membership of corresponding features may then be used to determine cluster representatives. Using such data, at step 408, feature comparison data for the clusters and features that is usable by a client application during feature engineering is determined. This may therefore include the features/feature vectors, clusters and cluster membership, and/or cluster representatives. The feature comparison data, such as cluster data from the clustering, may then be stored in a database and/or loaded in a data cache local or accessible to an application on a client device used for feature engineering.

At step 410, new feature parameters for a new feature are received in the application during feature engineering for an ML model. This may correspond to receiving a declarative feature logic definition or the like that includes input or selections of feature parameters and other feature logic (e.g., a source table, a transformation logic, a windowing parameter, or a filter definition). This may be selected and/or input through a UI system and UIs, menus, data entry fields, and the like for declarative feature engineering. At step 412, the new feature is compared to the existing features using the new feature parameters and the feature comparison data. For example, a vector or other representation may be generated for the new feature, which may then be used to calculate similarity scores to features, clusters, and/or cluster representatives in real-time during feature engineering and/or in response to the declarative feature logic definition being provided. The similarity scores may be used to find closest clusters and/or those clusters (and their representative) within a threshold distance and/or over a threshold score.

At step 414, it is determined if there are any similar clusters and/or cluster representatives using the vectors or other representatives for similarity score or distance calculations. If not, flowchart 400 may proceed to step 416 where feature engineering is continued, and the data scientist or other user may continue with feature engineering and/or creation of the feature based on the declarative feature logic definition and desired feature creation. However, if at step 414 it is determined there are similar clusters and/or cluster representatives, at step 418, similar feature(s) are suggested for replacement and/or use in place of the new feature. This may include populating one or more features most similar or having similarity scores meeting or exceeding a threshold score with the new feature. Further, the cluster correlated to the new feature may be identified and those features, or at least a portion of the member features, may be provided in the UI based on similarity scores. Other data for the comparison and matching may also be provided, such as the similarity scores, the preexisting feature's definition and logic, ML models using the feature, and the like.

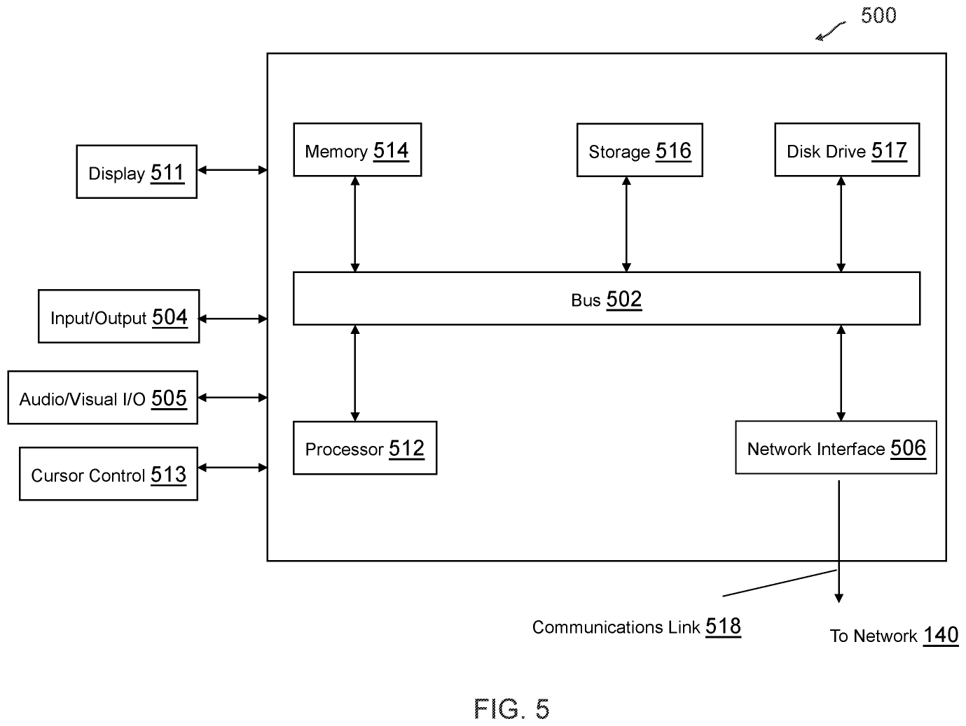

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
accessing a machine learning (ML) model configuration associated with an ML model deployable with a computing service of the system;
determining a first variable from a plurality of variables that enables a similarity detection based on the ML model configuration;
determining a first cluster of variables matching the first variable based on a vector similarity for a first variable vector representing the first variable and a cluster representative vector representing the first cluster of variables; and
presenting variable similarity data for at least one of the first cluster of variables or each variable in the first cluster of variables in a user interface associated with performing a variable engineering for the ML model.

2. The system of claim 1, wherein, prior to the accessing, the operations further comprise:
generating a plurality of variable clusters that includes the first cluster of variables and at least one second cluster of variables based on a plurality of variable vectors for the plurality of variables and an ML clustering technique;
storing the plurality of variable clusters; and
performing the similarity detection using one or more of the stored plurality of variable clusters.

3. The system of claim 2, wherein the ML clustering technique utilizes at least one of a k-nearest neighbors algorithm, a k-means algorithm, a means-shift algorithm, or a DBSCAN algorithm with a vector similarity scoring between at least one of each of the plurality of variable vectors or nearest neighbors of the plurality of variable vectors.

4. The system of claim 2, wherein the operations further comprise:
calculating a plurality of cluster representative vectors including the cluster representative vector based on the plurality of variable clusters,
wherein the plurality of cluster representative vectors are stored with the plurality of variable clusters and usable for performing the similarity detection.

5. The system of claim 2, wherein the determining the first cluster of variables matching the first variable is performed in real-time when generating variables and based on an input of at least one variable definition declaration or variable description data, and wherein the generating is precomputed prior to the accessing the ML model configuration.

6. The system of claim 1, wherein the presenting comprises:
displaying the variable similarity data in a list comprising at least one variable from the at least one of the first cluster of variables or each variable in the first cluster of variables in the user interface, wherein the list includes variable usage data for the at least one variable, and wherein the list enables selection and viewing of the at least one variable.

7. The system of claim 1, wherein, prior to the determining the first cluster of variables, the operations further comprise:
generating the first variable vector based on at least one variable parameter for the first variable; and
calculating the vector similarity using a vector similarity technique.

8. The system of claim 1, wherein the first variable and the plurality of variables each comprise a JavaScript Object Notation (JSON) container having variable logic comprising at least one of a source table, a transformation logic, a windowing parameter, or a filter definition.

9. The system of claim 1, wherein each of the plurality of variables is associated with a measurable datum usable by the ML model to generate an ML model output, wherein the operations further comprise receiving a selection of at least one variable parameter defining variable logic for the first variable during the variable engineering of the ML model, and wherein the presenting the variable similarity data occurs during the variable engineering based on the selection of the at least one variable parameter.

10. The system of claim 1, wherein the operations further comprise:
receiving a request to replace the first variable with a second variable from the first cluster of variables; and
replacing the first variable with the second variable in the ML model configuration.

11. A method comprising:
presenting a user interface comprising a plurality of options for a machine learning (ML) model configuration of an ML model by an ML model training system;
receiving a feature parameter for a feature usable by the ML model for an ML model output task;
generating a feature vector for the feature based at least on the feature parameter;
accessing a plurality of feature scores for a plurality of features preexisting with the ML model training system, wherein the plurality of feature scores are associated with a plurality of feature vectors for the plurality of features;
calculating a weighted distance between the feature vector and each of the plurality of feature vectors;
determining a first one of the plurality of features having a corresponding one of the weighted distances within a threshold distance to the feature vector; and
presenting the first one of the plurality of features in the user interface.

12. The method of claim 11, wherein the feature parameter is extracted from a data container for the feature or selected for the feature parameter during a feature engineering for the ML model.

13. The method of claim 12, wherein the feature parameter comprises one of a plurality of feature parameters for the feature in a plurality of feature fields for a configuration of the feature, and wherein the generating the feature vector is further based on the plurality of feature parameters.

14. The method of claim 11, wherein the feature comprises a JavaScript Object Notation (JSON) data structure comprising the feature parameter, and wherein the feature parameter comprises one of source data for the feature or processing logic for feature.

15. The method of claim 11, wherein prior to presenting the user interface, the method further comprises:
accessing the plurality of features for the ML model training system;
calculating the plurality of feature vectors for the plurality of features based on feature parameters for the plurality of features;
clustering the plurality of features by the plurality of feature vectors using an ML clustering technique; and
generating the plurality of feature scores for a plurality of feature clusters from the plurality of features.

16. The method of claim 15, further comprising:
generating a cluster representative for each of the plurality of feature clusters representing one or more of the plurality of feature vectors in each of the plurality of feature clusters,
wherein the plurality of feature scores are associated with the cluster representative.

17. The method of claim 11, wherein the first one of the plurality of features is presented in the user interface with an option to replace the feature in place of creating the feature as a new feature for the ML model training system via the user interface.

18. The method of claim 17, wherein the user interface comprises one or more menus that enable an establishment of at least one of source tables for the feature parameter or logic definitions for the feature parameter when creating the feature as the new feature for the ML model training system.

19. A non-transitory machine-readable medium having stored thereon machine-readable instructions executable to cause a machine to perform operations comprising:
receiving a plurality of machine learning (ML) features associated with at least one ML model deployed with decision services of a server provider system, wherein each of the plurality of ML features is associated with a measurable datum used by one or more of the at least one ML model for ML model outputs;
converting feature description data for each of the plurality of ML features to a corresponding vector representable in a vector space;
clustering the corresponding vectors for the plurality of ML features in the vector space using an ML clustering technique, wherein the ML clustering technique utilizes similarity scores between the corresponding vectors;
generating a cluster representative vector for each cluster from a plurality of clusters resulting from the clustering; and
storing cluster comparison data comprising the cluster representative vectors and the plurality of clusters that enables use with a feature engineering operation of an application.

20. The non-transitory machine-readable medium of claim 19, wherein the operations further comprise:
receiving a new feature being generated for the at least one ML model or a new ML model for the decision services;
comparing a new feature vector for the new feature to the cluster representative vectors for the plurality of clusters; and
presenting a result of the comparing via the application in association with the new feature.
